(19) United States
(12) Patent Application Publication
(10) Pub. No.: US 2025/0115311 A1
(43) Pub. Date: Apr. 10, 2025

(54) VEHICLE AERODYNAMICS

(71) Applicant: Gordon Murray Automotive Limited, Shalford (GB)

(72) Inventors: Duncan Green, Shalford (GB); Ian Gordon Murray, Puttenham (GB)

(21) Appl. No.: 18/833,277

(22) PCT Filed: Jan. 24, 2023
(86) PCT No.: PCT/EP2023/051690

§ 371 Date: Jul. 25, 2024

(30) Foreign Application Priority Data
Jan. 26, 2022 (GB) 2200989.8

(51) Int. Cl. B62D 35/02

(52) U.S. Cl. CPC B62D 35/02

(57) ABSTRACT

A diffuser element for the underside of a vehicle comprises in longitudinal vertical section, in sequence from front to rear, a first smoothly and monotonically rising panel, and a second panel, and a gap between the first and second panels, wherein the edge of the second panel adjacent the gap comprises a substantially flat planar section which is offset from and below the plane of the first panel ahead of the gap. This type of gap in the diffuser serves to bleed off the boundary layer from the airflow passing through the diffuser, thus enhancing its effectiveness and improving the downforce that is generated as a result. The gap is preferably located in the front half of the diffuser and can form the entrance to a duct leading to an exit on the rear of the vehicle.

### CROSS-REFERENCE TO RELATED APPLICATION

This Application is a Section 371 National Stage Application of International Application No. PCT/EP2023/051690, filed Jan. 24, 2023, and published as WO 2023/144144 on 3 Aug. 2023, in English, which claims priority to GB patent application number 2200989.8, filed on 26 Jan. 2022, the contents of which are hereby incorporated by reference in their entirety.

### FIELD OF THE INVENTION

The present invention relates to vehicle aerodynamics, especially in the rear section of the vehicle in and around the diffuser.

### BACKGROUND ART

Vehicle aerodynamics is concerned with controlling and directing the flow of air over and around a vehicle so as to contribute towards the performance and handling of the vehicle. The principal aims are to reduce the aerodynamic drag experienced by the vehicle and, in some implementations, to create downforce. Other considerations are to ensure that the drag and downforce characteristics are stable over a range of driving states so that the handling of the vehicle is predictable and safe.

Generally, the vehicle aerodynamics are controlled by the shape of the vehicle body over which the air flows, assisted and directed by aerodynamic elements which may be affixed to or form part of the body, such as splitters, spoilers, wings and diffusers. Splitters are located at the front lower part of the vehicle and direct air arriving at the vehicle; spoilers and wings are typically located at the upper rear of the vehicle and control air departing the vehicle to create downforce and/or adjust the vortex that forms behind the vehicle when moving.

A diffuser, in this context, is a shaped section of the vehicle's lower rear section which improves the car's aerodynamic properties by enhancing the transition between the high-velocity airflow underneath the car and the much slower freestream airflow of the ambient atmosphere behind the vehicle. It works by providing a space for the underbody airflow to decelerate and expand in volume so that it does not cause excessive flow separation and drag. Air passing beneath the vehicle is accelerated as it is funneled into the space between the vehicle and the ground, via Bernoulli's principle; this is beneficial in that the lower pressure which results creates a downforce effect, but if the high-velocity air is simply released into the lower-velocity air behind the vehicle then this will contribute to the turbulence in that area and add to the drag experienced by the vehicle. A diffuser therefore provides a more gradual opening of the underbody space, giving the high-velocity air space and time to decelerate.

The diffuser may be an integral part of the vehicle bodywork shaped and defined by the shape of that bodywork, or it may be formed by one or more panels attached to the vehicle, or some combination of the two.

Some Formula One teams developed a “double-diffuser” for the 2009 season, in response to changes in the championship regulations aimed at limiting the amount of aerodynamic elements that the car could carry. Unlike road cars, Formula One cars are characterised by two flat horizontal surfaces on their underside—the “reference plane” which is the lowest part of the chassis, and the “step plane” either side of the reference plane and slightly higher, with a vertical transition surface bridging the gap between them. The regulations for 2009 provided that both the reference and the step planes needed to be flat and uninterrupted, but was silent as to the transition surface. Some teams created apertures in the transition surface, allowing air that had been flowing under the step plane to escape laterally into a volume above the reference plane and feed what was in effect a second diffuser above the main diffuser, hence the term “double diffuser”.

The vast majority of diffusers (including the F1 “double-diffuser”) are passive devices in that their shape is determined, the diffuser panel is secured to or formed on the underside of the vehicle, and there is no further intervention. GB2269142 and WO2021/028234 propose arrangements in which the airflow beneath the vehicle is actively controlled by a suction fan which is able to selectively draw air from the diffuser; in GB2269142 this is to adjust the aerodynamic centre of pressure of the vehicle for balance purposes, and in WO2021/028234 it is to control the boundary layer and thereby adjust the balance between downforce and drag.

### SUMMARY OF THE INVENTION

The present invention therefore provides a vehicle comprising an aerodynamic element (such as a diffuser) on the underside thereof which includes, in sequence from front to rear, a first smoothly and monotonically rising panel, and a second panel, and a gap between the first and second panels, wherein the edge of the second panel adjacent the gap comprises a substantially flat planar section which is offset from and below a plane occupied by the first panel ahead of the gap.

This type of gap in the diffuser serves to bleed off the boundary layer from the airflow passing through the diffuser, thus enhancing its effectiveness and improving the downforce that is generated as a result.

The gap can form the entrance to a duct, which ideally leads smoothly to an exit formed on the rear of the vehicle, preferably without any intervening interruption to the airflow within the duct. In this way, the low-pressure wake or ‘base suction’ behind the vehicle formed as it passes through the air will provide a suction effect drawing air through the duct and enhancing the removal of the boundary layer. In this case, we prefer that the cross-sectional area of the duct increases monotonically along its length to the exit.

However, a duct is not strictly necessary and, depending on the particular characteristics of the vehicle in question, it may be better to omit the duct and its associated weight. Our investigations show that ducting the air bled via the gap to the rear of the car increases the effectiveness of the diffuser still further, but a reduction in weight is also beneficial. The choice between them will therefore be a choice for the designer to make in the light of their relative merits.

The part of the second panel to the rear of the substantially flat planar section adjacent the gap is ideally smoothly and monotonically rising in profile.

The gap is preferably located in the front half of the diffuser, typically forward of the centre of the rear wheels. Specifically, we prefer that the horizontal distance between the forward edge of the first panel and forward edge of the second panel is between 1/10 and ½ of the horizontal distance between the forward edge of the first panel and the rear of the vehicle.

A suitable width of the gap is between 10 and 50 mm, measured perpendicularly to the first panel.

To provide additional height in which to accommodate the diffuser, the underside of the vehicle can be shaped to define a first and second such aerodynamic element either side of a central spine which projects below the first and second panels. The central spine can then accommodate the vehicle driveline. The two driveshafts can each extend outwardly to a respective rear wheel. In such an arrangement, it is convenient for the ducts to pass above the driveshafts and for the second panels to be located below the driveshafts. Further, at least two of the rear suspension arms can extend outwardly from either side of the central spine and support a respective rear wheel, with the respective second panels of the aerodynamic elements located above those suspension arms.

In that case, the first and second aerodynamic elements are each ideally bounded on their respective outer lateral sides by an upright wall section which projects below the first and second panels, thus defining a channel on the underside of the vehicle for air to flow. That implies that the first and second panels are bounded on at least one lateral side by an upright wall section which projects below the first and second panels. Where the vehicle is designed with a central spine, that can assist in defining the channel.

The present invention also relates to a diffuser element for the underside of a vehicle comprising, in longitudinal vertical section, in sequence from front to rear, a first smoothly and monotonically rising panel, and a second panel, and a gap between the first and second panels, wherein the edge of the second panel adjacent the gap comprises a substantially flat planar section which is offset from and below the plane of the first panel ahead of the gap.

Alternatively, the diffuser can be defined as comprising, in sequence from front to rear, a first smoothly and monotonically rising panel extending from a point of minimum spacing of the aerodynamic element from the ground, an outlet, a second panel extending towards the rear of the vehicle and having a substantially flat section adjacent the outlet, wherein the outlet is defined between an upper face which meets the first panel smoothly and a lower face which meets the second panel at an acute angle.

Other aspects of the diffuser according to either definition are as set out above. For example, the horizontal distance between the point of minimum spacing from the ground and the join between the lower internal face and the second panel is between 1/10 and ½ the horizontal distance between the point of minimum spacing from the ground and the rear of the vehicle.

### BRIEF DESCRIPTION OF THE DRAWINGS

An embodiment of the present invention will now be described by way of example, with reference to the accompanying figures in which;

FIG. 1 shows the underside of a vehicle according to the present invention;

FIG. 2 shows a vertical section (on II-II of FIG. 1) through the relevant part of a vehicle according to a first embodiment of the present invention;

FIG. 3 shows airflow patterns under and through a vehicle according to the first embodiment;

FIG. 4 shows airflow patterns under and through a vehicle according to a second embodiment of the present invention;

FIG. 5 shows a vertical section through the relevant part of a vehicle according to a third embodiment of the present invention; and

FIG. 6 shows the opening of FIG. 5 in closer detail.

### DETAILED DESCRIPTION OF THE EMBODIMENTS

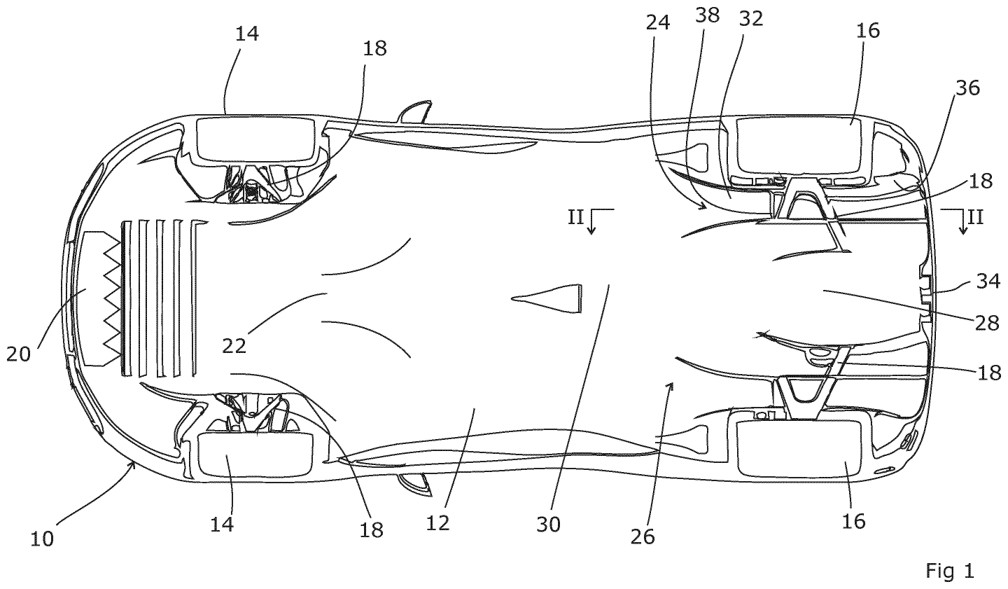

FIG. 1 shows the underside of a vehicle according to the present invention, in this instance a performance car 10. The underbody panel 12 has recesses towards each corner to accommodate front and rear wheels 14, 16, supported on suspension arms 18 which are connected to the car's chassis.

At the front 20 of the car 10, a ground effect inlet 22 channels air underneath the floor. A pair of diffuser structures 24, 26 are provided towards the rear of the car, either side of a central spine 28 which houses the chassis elements necessary to provide support for the rear suspension arms 18. The diffuser structures 24, 26 are defined by the shape of the underbody panel 12; as shown in FIG. 1 this is a single unitary panel, but in practice it will be made up of a number of smaller panel sections which collectively define the necessary shape.

Thus, air passing beneath the car 10 is directed rearwards by the ground effect inlet 22 towards a low point 30 just ahead of the diffuser structures 24, 26, creating a low-pressure area beneath the car according to Bernoulli's principle. This creates additional downforce for the car 10 in the conventional manner. It is assisted by the diffuser structures 24, 26 which allow the high-speed air passing through this (effective) venturi structure defined between the car 10 and the ground to be slowed before mixing with the air behind the vehicle.

Each diffuser structure 24, 26 comprises an upper panel structure 32 which rises generally towards the rear 34 of the car 10, passing horizontally over the lower rear suspension arms 18, and then rising again towards the rear of the car. The air flow path is bounded on an inner side by a substantially vertical wall provided by the central spine 28 and on an outer side by a substantially vertical wall section 36. Apertures (not visible) are provided in the spine 28 and the wall sections 36 to allow the suspension arms 18 to pass through them, and are large enough to allow the arms 18 to articulate under load.

An opening 38 is provided in the upper panel structures 32, part-way along each diffuser structures 24, 26 and just ahead of the horizontal section through the suspension arms. This is therefore ahead of the centreline of the rear wheels 16, and ahead of the rear suspension arms 18, but behind the frontmost extent of the rear wheels 16. It is, more generally, within the front half of the diffuser structures 24, 26. There should be some part of the diffuser ahead of the opening 38 in order to allow the correct airflow pattern to form, so we prefer that at least one-tenth of the diffuser length lies ahead of the opening 38.

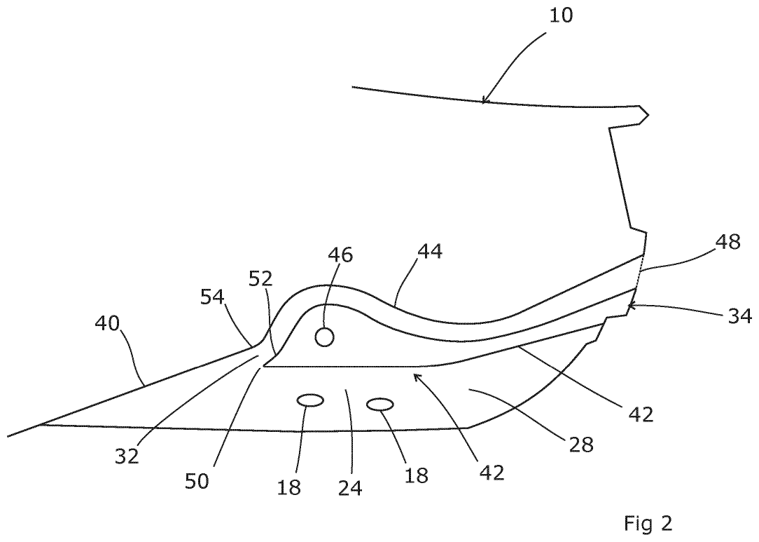

FIG. 2 shows a section along the line II-II of FIG. 1, and illustrates the shape of one of the diffuser structures 24. The upper panel structure 32 which defines the top surface of the diffuser 24 comprises a first upper panel 40 towards the front of the diffuser 24, ahead of the opening 32, and a second upper panel 42 extending from the opening 32 to the rear 34 of the car 10. The opening 32 is designed to bleed off the boundary layer from the air flowing over the first upper panel 40 into a duct 44. The duct 44 rises gently and smoothly to pass over the driveshaft 46 leading to the rear wheel 16 (not shown) and then to an exit 48 on the rear 34 of the car 10, covered with a grille. The duct 44 has a gently increasing cross-section to ease the airflow along it; there are (in this embodiment) no constrictions or other flow restrictions along its length.

The exit 48 opens into the region behind the car 10 in which so-called ‘base suction’ develops, a low-pressure region in the space behind the car 10 caused by its motion through the air. Thus, there is a distinct suction created in the duct 44 which helps draw the boundary layer air into the opening 32.

The opening 32 itself is formed so as to bleed off the boundary layer of the air flow over the first upper panel 40 before it reaches the second panel. In a passive system such as this, the bleed opening 32 should be a reasonable distance behind the front edge of the diffuser element so that an airflow pattern with a boundary layer is able to develop and stabilise ahead of the opening 32. We have found that a spacing between 1/10 and ½ the distance (horizontally) along the diffuser offers good performance. Thus, as shown in FIG. 2, after the smoothly rising flat first panel 40 under which the airflow can become established, the opening 32 defines an outlet for just the boundary layer of between 10 and 50 mm. A sharply-defined nose 50 divides the airflow into either the duct 44 for the boundary layer and the remainder of the diffuser under the second panel 42 which then continues horizontally through the rear suspension area. By joining the lower face 52 of the duct 44 to the second panel 42 at an acute angle, the sharp nose 50 is defined and creates a clean separation of the airflow into two. Likewise, by joining the upper face 54 of the duct 44 to the first panel smoothly, the boundary layer air flow into the opening 32 is preserved.

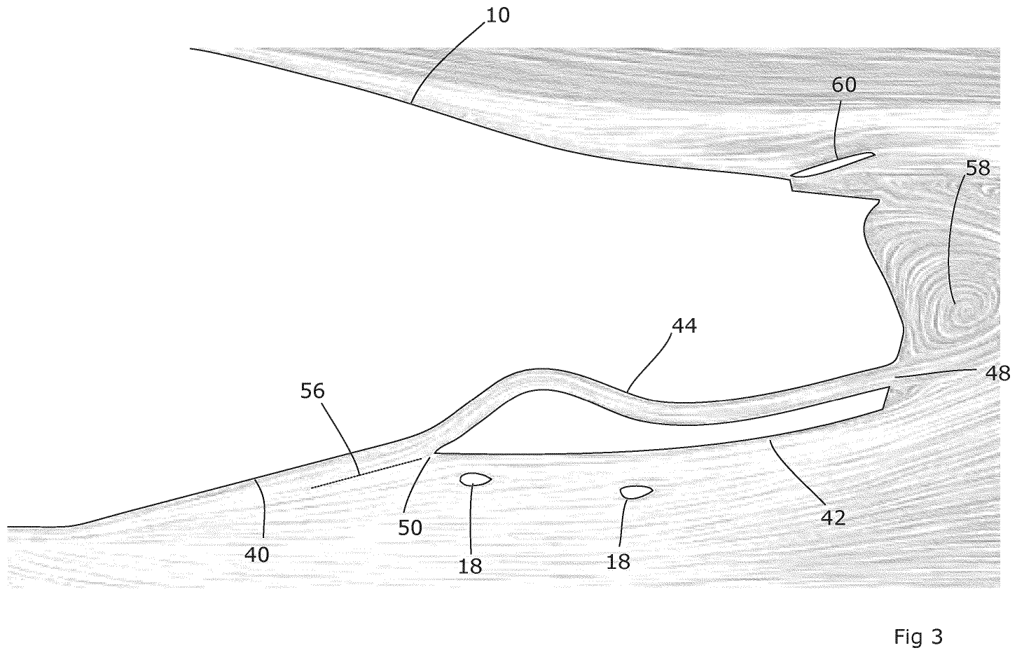

FIG. 3 shows the airflow that results from the diffuser arrangement of FIG. 2. The car 10 is shown as a negative space and the figure shows the airflow streamlines around the external profile of the car. It can be seen that the boundary layer 56 is effectively bled off into the duct 44 and the remainder of the airflow through the diffuser and into the region behind the car 10 is smooth and laminar; to assist this further, the suspension arms 18 have an aerodynamic cross-section. It is also noteworthy that the wake vortex 58 behind the car 10 is small and controlled.

Also visible in FIG. 3 is the optional active rear spoiler 60 at the upper rear edge of the car 10. This deploys automatically when needed, but can also be activated by the driver. The rear spoiler 60 provides a high downforce mode, increasing downforce. This additional downforce comes at the expense of additional drag, so the rear spoiler 60 also provides an aero enhanced braking function. Thus, automatic deployment is carried out when the car 10 detects that one or more of a tight cornering, potential oversteer, or hard braking situation exists.

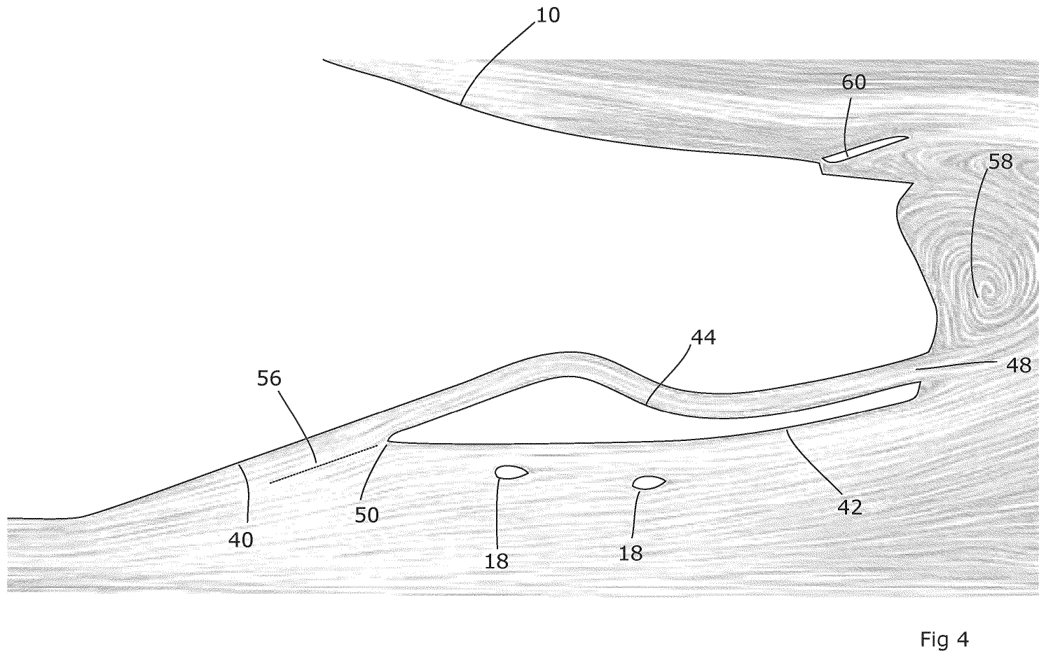

FIG. 4 shows a corresponding airflow pattern resulting from a different design of duct 44 with a lesser degree of deflection along its path. Such deflection might be needed in order to route the duct 44 within the interior of the car 10 around other elements such as driveshafts, suspension components and the like while providing adequate clearance. This has little effect on the airflow into and around the opening and behind the car 10, showing that the precise shape of the duct 44 is of relatively low importance.

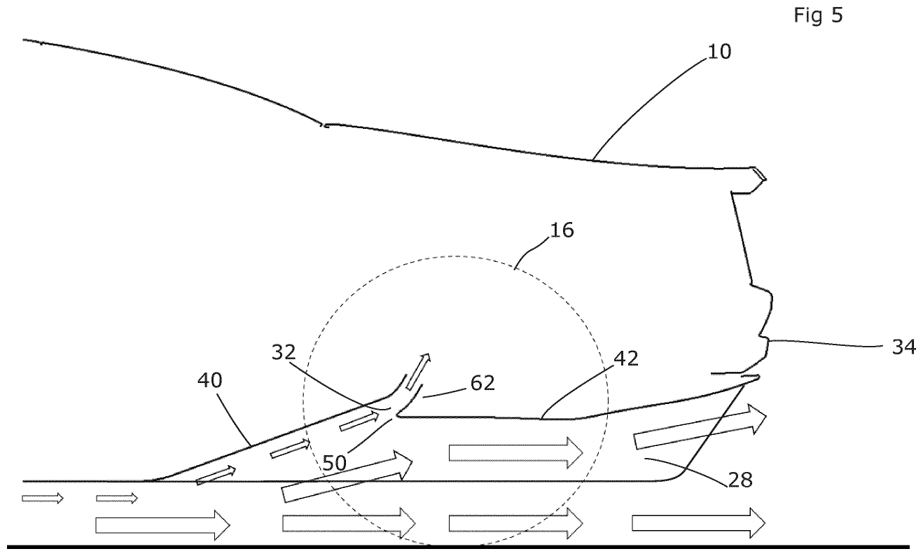

Indeed, the duct 44 can be omitted entirely. FIG. 5 shows a sectional view of the relevant parts of the car, in the same manner as FIG. 2, but including (dotted) the outline of a rear wheel 16 in lieu of the suspension arms 18 which are not shown. The same diffuser arrangement is provided, of a first panel 40 leading to an opening 32 defined with an acute nose 50 and a second panel 42 behind that. However, the duct 44 is omitted, truncated to leave only a short channel 62. This simply leads directly into the open space to the rear of the car in which the engine is located. Indeed, this vestigial channel 62 could itself be omitted in favour of a simple opening 32.

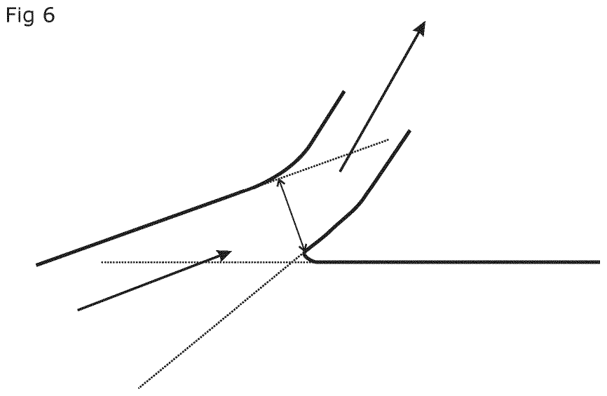

FIG. 6 shows the opening 32 in closer detail, illustrating that the plane 64 occupied by the first panel 40 ahead of the opening 32 lies above the acute nose 50 and the second panel 42, thus defining a depth 66 corresponding to the boundary layer 68 within the airflow 70 which is bled into the channel 62 or duct 44.

In examples with the boundary layer removal duct activated by the base suction behind the car, we have found that the invention enables a level of aerodynamic efficiency that is 30 percent more effective than a conventional ground effect supercar. With the boundary layer being bled into the engine compartment, i.e. without the benefit of the base suction, the aerodynamic efficiency is reduced slightly but the weight of the ducting is eliminated. Either might be preferable in a specific situation depending on the overall aerodynamic efficiency of the vehicle, its overall weight, the weight of the ducting involved, and the performance qualities required.

The ground effect dynamics provided by the invention contribute significantly to the aerodynamic performance of the vehicle and may alleviate or even obviate the need for obtrusive wings, skirts and vents that are common on modern-day supercars. These are visually unappealing and impose an additional drag burden. The boundary layer control enabled by the design and location of the bleed opening within the diffuser ensures the most effective interaction of airflow on top of, and below the car, harmonising drag, downforce, and stability at all speeds and alleviates the need for aggressive front end aerodynamics devices.

In this application, we refer in places to a ‘smooth’ surface or surfaces the meet ‘smoothly’. By this, we mean that the overall shape is one made up of curved surfaces only, with no sharp angular transitions, and ideally a radius greater than 100 mm. We also refer to certain items being ‘substantially flat’, which is a reference to them being horizontal in use when the vehicle is resting on its suspension and wheels, within the tolerance to be expected given the inherent resilience of the suspension systems involved.

It will of course be understood that many variations may be made to the above-described embodiment without departing from the scope of the present invention.

1. A vehicle comprising an aerodynamic element on the underside thereof which includes, in sequence from front to rear:
a first smoothly and monotonically rising panel, and
a second panel, and
a gap between the first and second panels, wherein an edge of the second panel adjacent the gap comprises a substantially flat planar section which is offset from and below a plane occupied by the first panel ahead of the gap.

2. A vehicle according to claim 1 in which the gap forms the entrance to a duct.

3. A vehicle according to claim 2 in which the duct leads smoothly to an exit formed on the rear of the vehicle.

4. A vehicle according to claim 3 in which the duct leads smoothly to the exit without any intervening interruption to airflow.

5. A vehicle according to claim 2 in which the cross-sectional area of the duct increases monotonically along its length to the exit.

6. A vehicle according to claim 1 in which the second panel comprises the substantially flat planar section adjacent the gap and, to the rear thereof, a smoothly and monotonically rising section.

7. A vehicle according to claim 1 in which the horizontal distance between the forward edge of the first panel and forward edge of the second panel is between 1/10 and ½ of the horizontal distance between the forward edge of the first panel and the rear of the vehicle.

8. A vehicle according to claim 1 in which the width of the gap at the entrance is between 10 and 50 mm, measured perpendicularly to the first panel.

9. A vehicle according to claim 1 in which the underside is shaped to define a first and second such aerodynamic element either side of a central spine which projects below the first and second panels.

10. A vehicle according to claim Error! Reference source not found, further comprising a pair of driveshafts, each extending outwardly and connected to a respective rear wheel, wherein the ducts pass above the driveshafts and the second panels are located below the driveshafts.

11. A vehicle according to claim 9 further comprising a plurality of suspension arms, at least two of which extend outwardly from either side of the central spine and support a respective rear wheel, wherein the respective second panels of the aerodynamic elements are located above the at least two suspension arms.

12. A vehicle according to claim 9 in which the first and second aerodynamic elements are each bounded on their respective outer lateral sides by an upright wall section which projects below the first and second panels.

13. A vehicle according to claim 1 in which the first and second panels are bounded on at least one lateral side by an upright wall section which projects below the first and second panels.

14. A vehicle according to claim 1, having an exterior body supported by front & rear wheels.

15. A vehicle according to claim 1 in which the gap is located forward of the centre of the rear wheels.

16. A diffuser element for the underside of a vehicle comprising, in sequence from front to rear:
a first smoothly and monotonically rising panel extending from a point of minimum spacing of the aerodynamic element from the ground,
an outlet,
a second panel extending towards the rear of the vehicle and having a substantially flat section adjacent the outlet, and
wherein the outlet is defined between an upper face which meets the first panel smoothly and a lower face which meets the second panel at an acute angle.

17. A diffuser element according to claim 16 in which the horizontal distance between the point of minimum spacing from the ground and the join between the lower internal face and the second panel is between 1/10 and ½ the horizontal distance between the point of minimum spacing from the ground and the rear of the vehicle.

18. A diffuser element for the underside of a vehicle comprising, in longitudinal vertical section, in sequence from front to rear:
a first smoothly and monotonically rising panel, and
a second panel, and
a gap between the first and second panels, wherein the edge of the second panel adjacent the gap comprises a substantially flat planar section which is offset from and below the plane of the first panel ahead of the gap.

19. A diffuser element according to claim 18 in which the horizontal length of the first panel is between 1/10 and ½ the horizontal length of the complete diffuser element.

20. A diffuser element according to claim 16 in which the second panel comprises the substantially flat planar section adjacent the gap and, to the rear thereof, a smoothly and monotonically rising section.

21. A diffuser structure for a vehicle comprising;
a diffuser element according to claim 16; and
a duct which leads smoothly from the outlet of the diffuser element to an exit formed on the rear of the vehicle.
